(19) United States
(12) Patent Application Publication
(10) Pub. No.: US 2020/0288508 A1
(43) Pub. Date: Sep. 10, 2020

(54) Bandwidth Part Operation for Random Access in RRC Connected Mode

(71) Applicant: GUANGDONG OPPO MOBILE TELECOMMUNICATIONS CORP., LTD., Dongguan (CN)

(72) Inventors: Cong Shi, Dongguan (CN); Weijie Xu, Dongguan (CN)

(21) Appl. No.: 16/881,465

(22) Filed: May 22, 2020

Related U.S. Application Data
(63) Continuation of application No. PCT/CN2018/117532, filed on Nov. 26, 2018.
(60) Provisional application No. 62/591,546, filed on Nov. 28, 2017.

(51) Int. Cl. H04W 74/08

(52) U.S. Cl. CPC H04W 74/0833; H04W 84/042

(57) ABSTRACT

A method of initiating a Random Access communication between a 5G User Equipment (UE) and a 5G network node; the method comprising: if the current active UL-BWP of the UE has valid PRACH resources, the UE sending the Random Access Preamble on said current active UL-BWP; and if the current active UL-BWP of the UE has no valid PRACH resources, the UE sending the Random Access Preamble on the initial UL BWP; the method further comprising the UE monitoring the RAR in one of the initial DL-BWP and a default DL-BWP.

### CROSS-REFERENCE TO RELATED APPLICATION(S)

The present application is a continuation application of International PCT Application No. PCT/CN2018/117532, filed on Nov. 26, 2018, which claims priority to U.S. provisional application No. 62/591,546, filed on Nov. 28, 2017. The present application claims priority and the benefit of the above-identified applications and the above-identified applications are incorporated by reference herein in their entireties.

### TECHNICAL FIELD

The present disclosure relates generally to communication systems. More specifically, the present disclosure relates to systems and methods for initiating enhanced random access communication in the fifth generation mobile communication technology

### BACKGROUND

The development of Mobile Internet, Internet of Things and other service applications has become a main driving force for the development of the fifth generation mobile communication technology (5G); and there is a strong demand for the 5G to for example allow optical fibers grade access rate, widespread connectivity, widespread wireless broadband access, high energy efficiency, high spectral efficiency, etc.

The 5G, as defined by the 3rd Generation Partnership Project (3GPP) International Organization for Standardization, is expected to address random access between a User Equipment (UE) and a network node in a way similar to a Long Term Evolution (LTE) system.

### SUMMARY

An implementation of this disclosure relates to a method of initiating a Random Access communication between a 5G User Equipment (UE) and a 5G network node; the method comprising: if the current active UL-BWP of the UE has valid PRACH resources, the UE sending the Random Access Preamble on said current active UL-BWP; and if the current active UL-BWP of the UE has no valid PRACH resources, the UE sending the Random Access Preamble on the initial UL BWP; the method further comprising: the UE monitoring the RAR in the initial DL-BWP.

Another implementation of this disclosure relates to a method of initiating a Random Access communication between a 5G User Equipment (UE) and a 5G network node; the method comprising: if the current active UL-BWP of the UE has valid PRACH resources, the UE sending the Random Access Preamble on said current active UL-BWP; and if the current active UL-BWP of the UE has no valid PRACH resources, the UE sending the Random Access Preamble on the initial UL BWP; the method further comprising: the UE monitoring the RAR in a default DL-BWP.

According to an implementation of this disclosure, the default DL-BWP can be the DL-BWP with the same index as that of the current active UL-BWP. For example, if the current active UL-BWP has PRACH resources, and the ID of the current active UL BWP is 2, then the UE switches the current active DL BWP to the DL BWP with ID 2.

Another implementation of this disclosure relates to a method of initiating a Random Access communication between a 5G User Equipment (UE) and a 5G network node; the method comprising: the UE sending the Random Access Preamble on the initial UL-BWP; and the UE monitoring the RAR in the initial DL-BWP.

Another implementation of this disclosure relates to a method of initiating a Random Access Communication between a 5G User Equipment (UE) and a 5G network node; the method comprising the UE sending the Random Access Preamble on the initial UL-BWP; and the UE monitoring the RAR in a default DL-BWP.

According to an implementation of the disclosure, the PRACH resources are defined according to a legacy 3GPP standard.

According to an implementation of the disclosure, the method comprises the UE receiving a definition of the PRACH resources in a SIB message issued by the network node prior to sending the Random Access Preamble.

According to an implementation of the disclosure, the method comprises the UE receiving higher layer information about the initial UL-BWP and the initial DL-BWP prior to sending the Random Access Preamble.

According to an implementation of the disclosure, the method comprises the network node sending a Random Access Response in reply to the Random Access Preamble on the initial DL-BWP.

Implementations of the Disclosure are also directed at apparatuses arranged, by hardware and/or by programming, to implement the methods outlined above.

### BRIEF DESCRIPTION OF DRAWINGS

The accompanying drawings, which are incorporated in and form a part of this specification, illustrate implementations of the disclosure and, together with the description, serve to explain the principles of the implementations of the present disclosure as hereby described. Identical reference numbers represent identical features in the various figures. The figures are not drawn to scale.

FIG. 1 illustrates a random access procedure of related art.

FIG. 2 illustrates an uplink channel of related art.

FIG. 3 illustrates a downlink channel of related art.

FIGS. 4 and 5 illustrate a method according to an implementation of the present disclosure.

FIGS. 6 and 7 illustrate a method according to another implementation of the present disclosure.

FIG. 8 illustrates a method according to another implementation of the present disclosure.

FIG. 9 illustrates a method according to another implementation of the present disclosure.

### DETAILED DESCRIPTION

The following description is presented to enable one of ordinary skill in the art to make and use the teachings of this presentation and to incorporate them in the context of particular applications. Various modifications, as well as a variety of uses in different applications will be readily apparent to those skilled in the art, and the general principles defined herein may be applied to a wide range of implementations. Thus, the present disclosure is not intended to be limited to the implementations presented, but is to be accorded the widest scope consistent with the principles and novel features disclosed herein.

In the following detailed description, numerous specific details are set forth in order to provide a more thorough understanding of implementations of this presentation. However, it will be apparent to one skilled in the art that such implementations may be practiced without necessarily being limited to these specific details.

All the features disclosed in this presentation, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

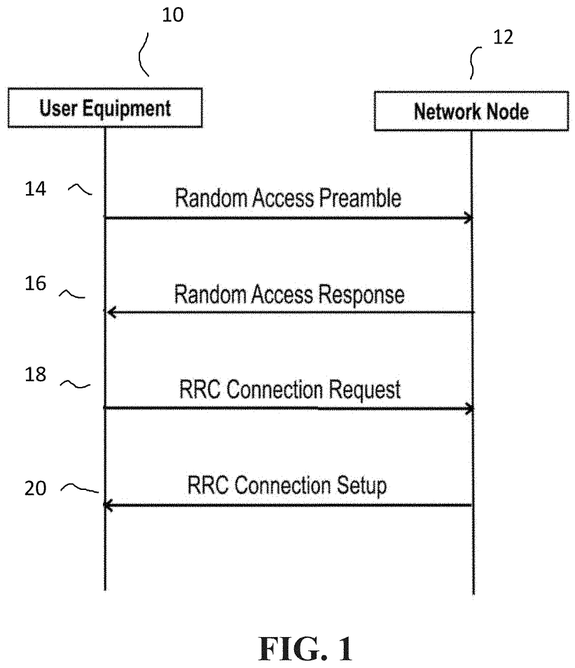

FIG. 1 illustrates a random access procedure of related art. During initial access, a user equipment (UE) 10 seeks access to a network node 12 of a network (not shown) in order to register and communicate. The random access procedure serves as an uplink control procedure to enable the UE to access the network and acquire proper uplink timing (synchronize uplink). Since the initial access attempt cannot be scheduled by the network, the initial random access procedure is contention based. Collisions may occur and a contention-resolution scheme is therefore implemented. As detailed hereafter, the related art provides for first transmitting a Random Access Preamble, whose purpose is to obtain uplink synchronization, before eventually transmitting user data.

Generally, the reasons for initiating the random access procedure comprise: Initial access from RRC_IDLE; RRC Connection Re-establishment procedure; Handover; DL or UL data arrival during RRC_CONNECTED when UL synchronization status is “non-synchronized”; Transition from RRC_INACTIVE; To establish time alignment at SCell addition; Request for Other System Information (SI); and Beam failure recovery.

When the UE wants to transmit uplink data, it needs to be in RRC_CONNECTED mode, have its uplink synchronized (assigned MAC time alignment timer has not expired), and have scheduling request resources configured. If any of these requirements is not met, the UE initiates the random access procedure. The goal of the random access procedure is to acquire proper uplink timing to enable the UE to send uplink data.

FIG. 1 outlines a basic random access procedure. The figures illustrate messages communicated between UE 10 and network node 12, such as an enhanced Node B or “eNB.” FIG. 1 illustrates a contention based random access procedure in the case of initial access. At step 14, the UE 10 sends a Random Access Preamble to the network node 12. In related art, the random access preambles are transmitted over the Physical Random Access Channel (PRACH), which is detailed hereafter, whereby the transmission of preambles is limited to certain time and frequency resources. The PRACH time and frequency resources are configured by upper layers (in the SIB-2 system information message periodically emitted by the Network Node). For Frequency Division Duplex (FDD—frame structure format 1), the PRACH frequency can currently vary from every subframe to once in every other radio frame (i.e., once in every 20 ms).

As also detailed hereafter, the PRACH resource has a bandwidth corresponding to 6 physical resource blocks. The length of the PRACH preamble in time depends on the preamble format being used. The configuration of the PRACH resources in a cell is done by RRC protocol, and the configuration is the same for all UEs in a cell.

At step 16, the network node 12 sends the UE 10 a random access response. In related art, the random access response can be sent using the Physical Downlink Shared Channel (PDSCH), as detailed hereafter. The random access response includes an uplink grant for the UE 10. At step 18, the UE 10 sends the network node an RRC Connection Request. The message is sent using the uplink resources assigned by the network node in step 16. The message requests to establish a connection at the radio resource control (RRC) layer. In related art, the RRC Connection Request can be sent on the Physical Uplink Shared Channel (PUSCH), as detailed hereafter. At step 20, the network node 12 sends the UE 10 an RRC Connection Setup message in order to establish the RRC connection. In return, the UE 10 can send a RRC connection complete message (not illustrated). It is to be noted that a RRC connection Request (in msg3) and a corresponding RRC connection complete message (in msg4) are just one of the use cases of RACH procedure when the RACH is initiated by UE switching from IDLE to CONNECTED mode. When RACH is initiated by other events, for example, when uplink syncro is not obtained, the msg3 may not include RRC connection request message.

The above protocol avoids contention by including, in the Random Access Response issued by the network node 12, an identifier derived from the Random Access Preamble, that allows UE 10 to know that the network node 12 responds to the UE 10 and not to another UE (not illustrated) that would also be awaiting for a Random Access Response.

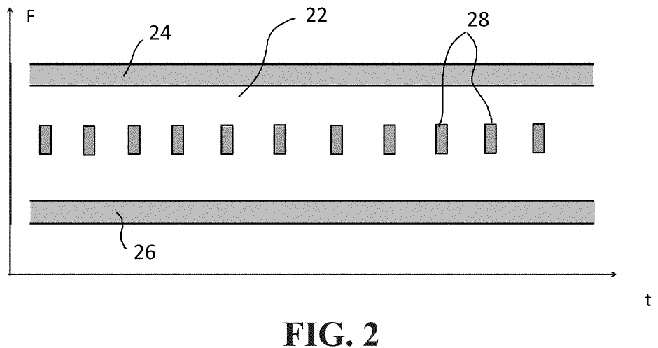

FIG. 2 illustrates a uplink channel frequency map as a function of time, comprising essentially a wide Physical Uplink Shared Channel (PUSCH) 22 that occupies most of the bandwidth available for upload, and two narrow edge channels/bands 24, 26 forming together a Physical Uplink Control Channel (PUCCH). Further, narrow channels 28 forming a Physical Random Access Channel (PRACH), having a frequency height of 6 Resource Blocks (RB) each and a time length that can vary with the modulation scheme used, are periodically present at a determined location of the PUSCH 22. As outlined above, the PRACH time and frequency resources are configured in a SIB-2 message that is periodically emitted by the Network Node.

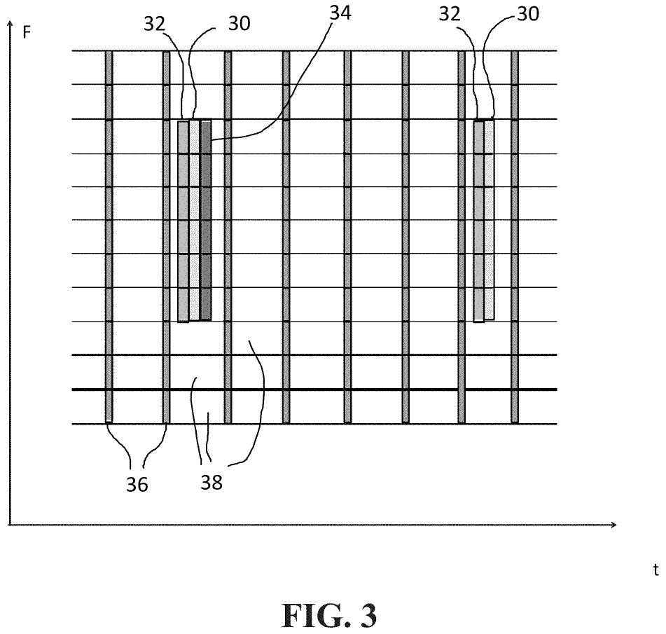

FIG. 3 illustrates a downlink channel frequency map as a function of time. FIGS. 2 and 3 are not drawn to scale. The downlink channel comprises, repeated twice every 10 ms, a Primary Synchronization Signal (PSS) channel 30 and a Secondary Synchronization Signal (SSS) channel 32 having each a height of 6 RB. The downlink channel further comprises, repeated once every 10 ms, a Physical Broadcast Channel (PBCH) 34 having also a height of 6 RB. The PBCH broadcasts a Master Information Block (MIB) specific to the network node 12, which allows UE 10 to access a Physical Downlink Control Channel (PDCCH) 36 that is repeated every 1 ms and is essentially as high as the bandwidth available for Downlink. The remainder of the RBs that form the downlink channel form the Physical Downlink Shared Channel (PDSCH) 38, which broadcasts the data directed at the various UEs in communication with the network node. The PDCCH 36 broadcasts numerous information, in particular the SIB-2 signal that defines the PRACH as outlined above. The PDCCH 36 also contains a mapping of what RB contains data dedicated to what UE.

In addition to the above considerations, in a 5G RRC connection setup, the UE can be configured with up to four BandWidth Parts (BWP) in the downlink—with a single DownLink BandWidth Part (DL-BWP) being active at a given time- and with up to four BWP in the uplink—with a single UpLink BWP being active at a given time-. The UE is not expected to receive PDSCH, PDCCH, or CSI-RS (except for RRM) outside its active DL-BWP. The UE shall not transmit on PUSCH or PUCCH outside its active UL-BWP.

BWP selection (or BWP switching) can be done by several different ways as listed below:

By PDCCH (i.e, DCI): A specific BWP can be activated by Bandwidth part indicator in DCI Format 1_1 (a UL Grant) and DCI Format 0_1 (a DL Schedule)

By the bwp-InactivityTimer: ServingCellConfig.bwp-InactivityTimer

By RRC signalling

By the MAC entity itself upon initiation of Random Access procedure

Using the mechanisms listed above, a specific BWP become active depending on various situations in the call processing.

The inventors have noted that, because 5G provides that the UL-BWP of a UE can be changed during the operation of the UE, it is not certain that the UL-BWP that is active at any given time has actually valid PRACH resources. It follows that, if for any reason the UE wants to initiate a Random Access Communication, at any time, it may have to change from its active UL-BWP to a UL-BWP having valid PRACH resources. The inventors have also noted that, because 5G provides that a network node that receives a Random Access Preamble does not know the configuration of the UE that has sent the Random Access Preamble, the network node has no way to know what is the active DL-BWP of the UE, and thus does not know on which DL-BWP to send the Random Access Response. A solution is for the Network Node to send the Random Access Response on all the DL-BWP for all the UEs. However, this solution leads to a low resource efficiency.

There remains a need for a method of initiating a Random Access communication in 5G that has a good resource efficiency.

An initial DL/UL BWP pair is active for a UE until the UE is explicitly (re)configured with bandwidth part(s) during or after RRC connection is established.

Further, the initial active DL/UL BWP is confined within the UE minimum bandwidth for the given frequency band.

It is noted that the activation/deactivation of the DL BWP of a UE can result from a timer instructing the UE to switch its active DL-BWP to a default DL-BWP.

It is noted that the default DL-BWP can be—or not-the initial active DL-BWP of the UE.

As outlined above, when a random access is initiated from a UE in RRC connected mode, because the UL-BWP and/or the DL-BWP of the UE may have been changed for a number of reasons, internally (e.g. as a result of a timer instruction) or externally (e.g. in response to a node instruction for facilitating data upload), it is not certain at all that the active UL-BWP of the UE actually has valid PRACH resources, and it is not known what the active DL-BWP of the UE is when a Random Access is to be initiated by the UE. Thus, as also outlined above, when a random access is initiated from a UE in RRC connected mode, when the UE sends the Preamble in its activated UL-BWP, the network actually does not know from which UE the preamble comes from, so the network node does not know how to send the random access response.

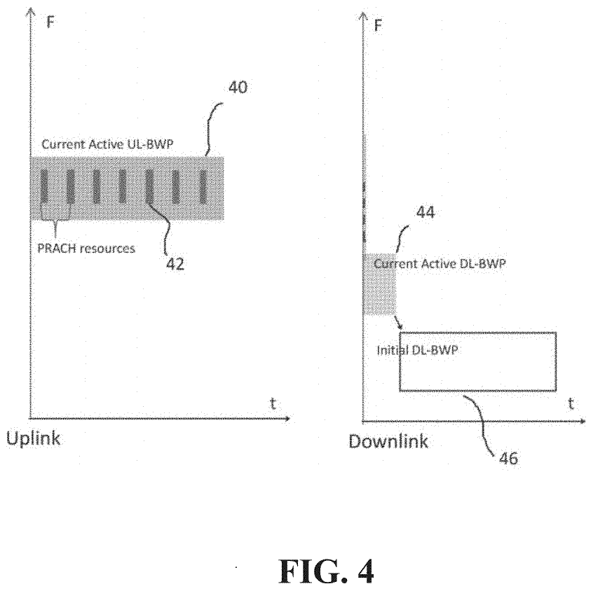

FIG. 4 illustrates a method, according to an implementation of the present disclosure, of initiating a Random Access communication between a 5G UE and a 5G network node. According to an implementation, the PRACH resources are defined according to a legacy 3GPP standard; for example the related art illustrated in FIG. 1. Thus, it can be considered that the UE 10 in FIG. 1 can be a 5G UE according to an implementation of this disclosure and that the node 12 in FIG. 1 can be a 5G network node according to an implementation of this disclosure. As outlined with respect to FIG. 1, UE 10 can receive a definition of the PRACH resources in a SIB-2 message issued by the network node 12 prior to sending the Random Access Preamble.

The left portion of FIG. 4 illustrates the active UL-BWP of the UE and the right portion of FIG. 4 illustrates the active DL-BWP of the UE. The unused/inactive UL-BWP and DL-BWP of the UE are not illustrated for clarity. FIG. 4 illustrates a case where the active UL-BWP 40 of the UE happens to have valid PRACH resources 42. According to the present implementation of this disclosure, in such a case the UE sends the Random Access Preamble 14 on its current active UL-BWP 40. According to an implementation of the present disclosure, the UE 12 can receive higher layer information about the initial UL-BWP and the initial DL-BWP prior to sending the Random Access Preamble. For example, initial BWP, can be determined by the frequency band on which the SSB is received (where SSB is a combined signaling block sent from network to UE including MIB, PSS, SSS outlined here above).

Further, according to this implementation of the Disclosure, by convention the UE will monitor the Random Access Response (RAR) in its initial DL-BWP 46, whatever its current active DL-BWP 44 at the time the Random Access Preamble is sent. As outlined above in relation with FIG. 1, the network node 12 is arranged for sending a Random Access Response in reply to the Random Access Preamble from UE 10. According to this implementation of the present disclosure, the network node is accordingly programmed for, when receiving a Random Access Preamble, sending the Random Access Response on the initial DL-BWP 46 of the cell—and therefore of the UE—(the initial BWP is not necessarily the same for all the cells. However, it's the same for all the UEs in the same cell).

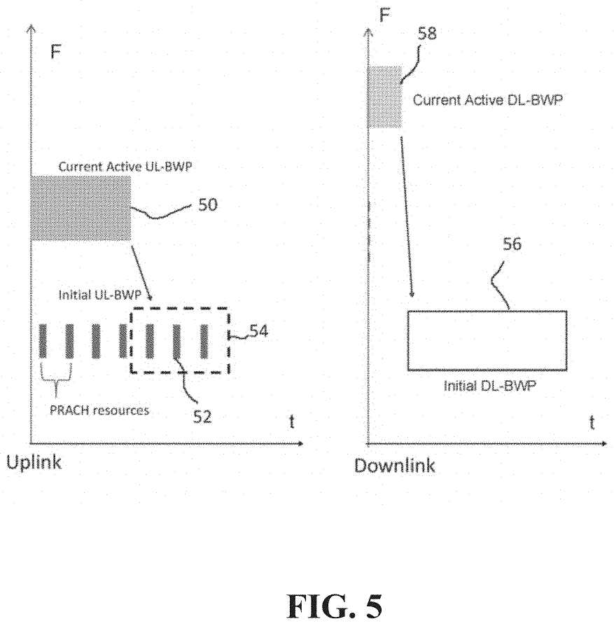

FIG. 5 illustrates an operation of the same implementation as in FIG. 4, where the active UL-BWP 50 of the UE 10 happens to not have valid PRACH resources 52. According to the present implementation of this disclosure, in such a case the UE 10 switches to its initial UL-BWP 54, which has the valid PRACH resources 52, and sends the Random Access Preamble 14 on initial UL-BWP 54.

As in FIG. 4, according to this implementation of the present Disclosure, the UE will monitor the Random Access Response (RAR) in its initial DL-BWP 56, whatever its current active DL-BWP 58 at the time the Random Access Preamble is sent; and the network node must be programmed for sending the Random Access Response on the initial DL-BWP 56.

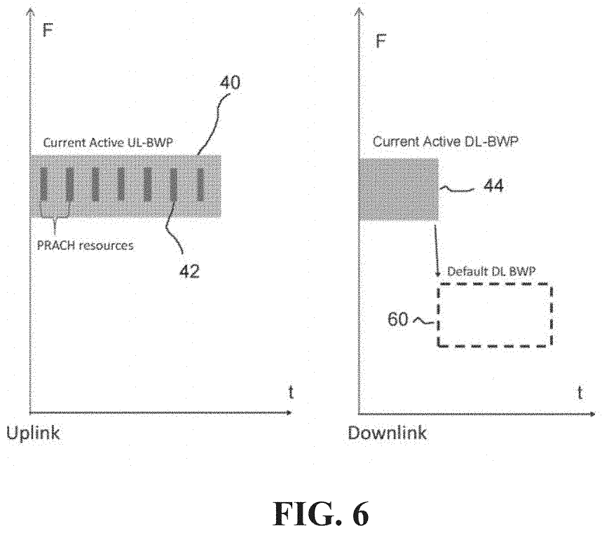

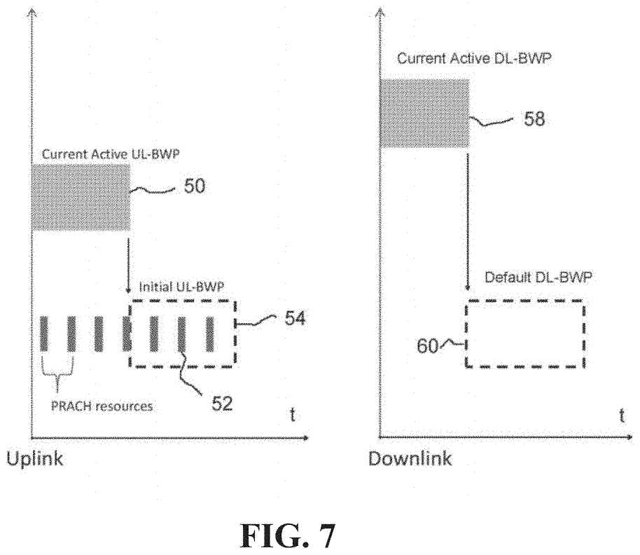

FIG. 6 illustrates a method, according to a second implementation of the present disclosure, of initiating a Random Access communication between a 5G UE 10 and a 5G network node 12. The implementation illustrated in FIGS. 6 and 7 is similar to the implementation illustrated in FIGS. 4 and 5, but differs in that instead of having the UE 10 arranged for monitoring the Random Access Response (RAR) in its initial DL-BWP, whatever its current active DL-BWP 44 at the time the Random Access Preamble is sent, the UE 10 is arranged for monitoring the Random Access Response (RAR) in a default DL-BWP 60. According to an implementation of this disclosure, the default DL-BWP can be the DL-BWP with the same index as that of the current active UL-BWP. For example, if the current active UL-BWP has PRACH resources, and the ID of the current active UL BWP is 2, then the UE switches the current active DL BWP to the DL BWP with ID 2.

As outlined above in relation with FIG. 1, the network node 12 is arranged for sending a Random Access Response in reply to the Random Access Preamble from UE 10. According to this implementation of the present disclosure, the network node is accordingly programmed for, when receiving a Random Access Preamble, sending the Random Access Response on the default DL-BWP 60.

FIG. 7 illustrates an operation of the same implementation as in FIG. 6, where the active UL-BWP 50 of the UE 10 happens to not have valid PRACH resources 52. According to the present implementation of this disclosure, in such a case the UE 10 switches to its initial UL-BWP 54, which has the valid PRACH resources 52, and sends the Random Access Preamble 14 on initial UL-BWP 54.

As in FIG. 6, according to this implementation of the present Disclosure, the UE 10 will monitor the Random Access Response (RAR) in a default DL-BWP 60, whatever its current active DL-BWP 58 at the time the Random Access Preamble is sent; and the network node must be programmed for sending the Random Access Response on the default DL-BWP 60.

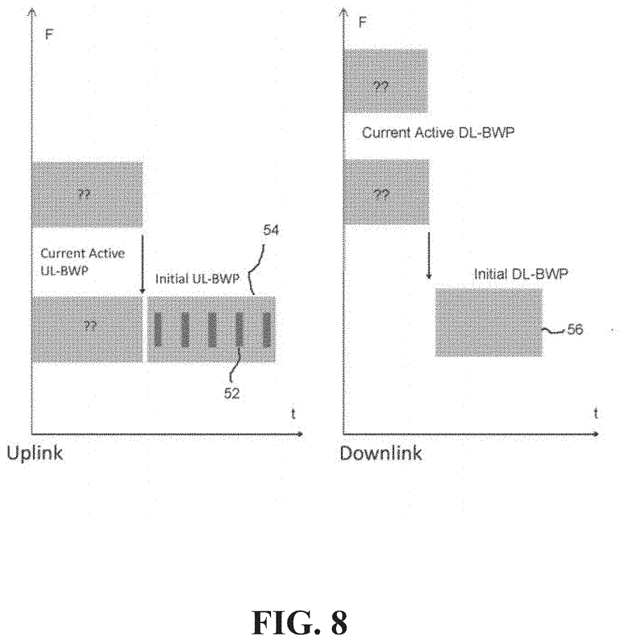

FIG. 8 illustrates a method, according to a third implementation of the present disclosure, of initiating a Random Access communication between a 5G UE 10 and a 5G network node 12. The implementation illustrated in FIG. 8 is similar to the implementations illustrated in FIGS. 4/5 and 6/7, but differs essentially in that the UE 10 is arranged to switch to its initial UL-BWP 54, which has the valid PRACH resources 52, whatever its current active UL-BWP is. According to the implementation in FIG. 8, as in the implementation of FIGS. 4 and 5, the UE 10 is arranged for monitoring the Random Access Response (RAR) in its initial DL-BWP 56, whatever its current active DL-BWP is. In FIG. 8, the references “??” indicate that it is now known which UL-BWP or DL-BWP is active, and it does not matter because the UE 10 is arranged to switch to its initial UL-BWP 54 and DL-BWP 56 whatever its current active UL-BWP and DL-BWP are.

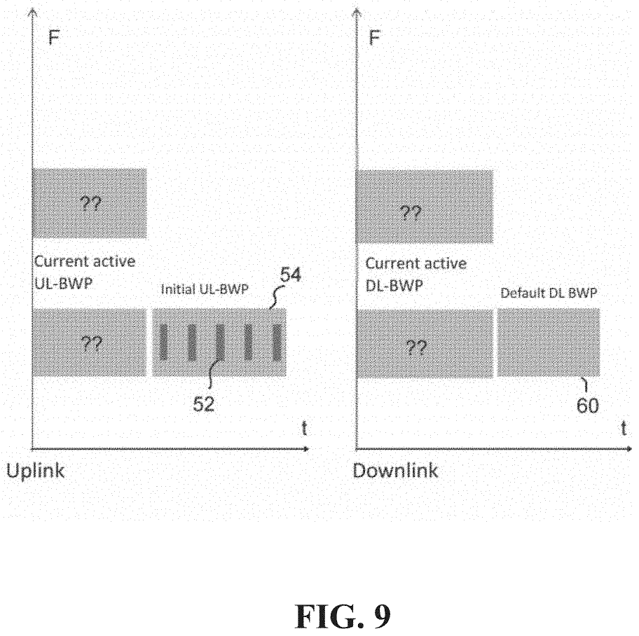

FIG. 9 illustrates a method, according to a fourth implementation of the present disclosure, of initiating a Random Access communication between a 5G UE 10 and a 5G network node 12. The implementation illustrated in FIG. 9 is similar to the implementation illustrated in FIG. 8, but differs essentially in that, as in the implementation of FIGS. 6 and 7, the UE 10 is arranged for monitoring the Random Access Response (RAR) in a default DL-BWP 60, whatever its current active DL-BWP is. In FIG. 9, the references “??” indicate that it is now known which UL-BWP or DL-BWP is active, and it does not matter because the UE 10 is arranged to switch to its initial UL-BWP 54 and default DL-BWP 60 whatever its current active UL-BWP and DL-BWP are.

The present disclosure also relates to apparatuses (UE, network nodes) arranged for implementing the above described methods according to implementations of the disclosure. The apparatuses can be arranged so by using a hardware specifically made to implement said methods, or storing a program stored on a storage medium that, when run, implements said methods. The present disclosure also relates to a storage medium storing a program that, when run, implements at least one of said methods.

Having now described the disclosure in accordance with the requirements of the patent statutes, those skilled in this art will understand how to make changes and modifications to the present disclosure to meet their specific requirements or conditions. Such changes and modifications may be made without departing from the scope and spirit of the disclosure as disclosed herein.

The foregoing Detailed Description of exemplary and preferred implementations is presented for purposes of illustration and disclosure in accordance with the requirements of the law. It is not intended to be exhaustive nor to limit the disclosure to the precise form(s) described, but only to enable others skilled in the art to understand how the disclosure may be suited for a particular use or implementation. The possibility of modifications and variations will be apparent to practitioners skilled in the art. No limitation is intended by the description of exemplary implementations which may have included tolerances, feature dimensions, specific operating conditions, engineering specifications, or the like, and which may vary between implementations or with changes to the state of the art, and no limitation should be implied therefrom.

Applicant has made this disclosure with respect to the current state of the art, but also contemplates advancements and that adaptations in the future may take into consideration of those advancements, namely in accordance with the then current state of the art. It is intended that the scope of the disclosure be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step (s) of . . . .”

All elements, parts and steps described herein are preferably included. It is to be understood that any of these elements, parts and steps may be replaced by other elements, parts and steps or deleted altogether as will be obvious to those skilled in the art.

What is claimed is:

1. A method of initiating a Random Access communication; the method comprising:
based on a determination that a current active UpLink BandWidth Part (UL-BWP) of a User Equipment (UE) has valid Physical Random Access Channel (PRACH) resources, the UE sending a Random Access Preamble on the current active UL-BWP; and
based on a determination that the current active UL-BWP of the UE has no valid PRACH resources, the UE sending the Random Access Preamble on an initial UL-BWP; and
the method further comprising:
the UE monitoring a Random Access Response (RAR) in an initial DownLink BandWidth Part (DL-BWP).

2. The method of claim 1, wherein the PRACH resources are defined according to a legacy 3rd Generation Partnership Project (3GPP) standard.

3. The method of claim 1, comprising the UE receiving a definition of the PRACH resources in a System Information Block (SIB) message prior to sending the Random Access Preamble.

4. The method of claim 1, comprising the UE receiving higher layer information about the initial UL-BWP and the initial DL-BWP prior to sending the Random Access Preamble.

5. The method of claim 1, comprising the UE receiving a Random Access Response in reply to the Random Access Preamble on the initial DL-BWP.

6. A method of initiating a Random Access communication; the method comprising: a User Equipment (UE) sending a Random Access Preamble on an initial UpLink BandWidth Part (UL-BWP); and
the UE monitoring a Random Access Response (RAR) in an initial DownLink BandWidth Part (DL-BWP).

7. The method of claim 6, wherein Physical Random Access Channel (PRACH) resources are defined according to a legacy 3rd Generation Partnership Project (3GPP) standard.

8. The method of claim 7, comprising the UE receiving a definition of the PRACH resources in a System Information Block (SIB) message prior to sending the Random Access Preamble.

9. The method of claim 6, comprising the UE receiving higher layer information about the initial UL-BWP and the initial DL-BWP prior to sending the Random Access Preamble.

10. The method of claim 6, comprising the UE receiving a Random Access Response in reply to the Random Access Preamble on the initial DL-BWP.

11. A user equipment, UE, comprising: a memory and a processor, the memory storing one or more computer programs that, when executed by the processor, cause the processor to execute operations of:
sending a Random Access Preamble on a current active UpLink BandWidth Part (UL-BWP) when the current active UL-BWP of a User Equipment (UE) has valid Physical Random Access Channel (PRACH) resources;
sending the Random Access Preamble on an initial UL-BWP when the current active UL-BWP of the UE has no valid PRACH resources; and
monitoring a Random Access Response (RAR) in an initial DownLink BandWidth Part (DL-BWP).

12. The UE of claim 11, wherein the PRACH resources are defined according to a legacy 3rd Generation Partnership Project (3GPP) standard.

13. The UE of claim 11, wherein the processor is further caused to execute an operation of receiving a definition of the PRACH resources in a System Information Block (SIB) message prior to sending the Random Access Preamble.

14. The UE of claim 11, wherein the processor is further caused to execute an operation of receiving higher layer information about the initial UL-BWP and the initial DL-BWP prior to sending the Random Access Preamble.

15. The UE of claim 11, wherein the processor is further caused to execute an operation of receiving a Random Access Response in reply to the Random Access Preamble on the initial DL-BWP.

16. A user equipment, UE, comprising: a memory and a processor, the memory storing one or more computer programs that, when executed by the processor, cause the processor to execute operations of:
sending a Random Access Preamble on an initial UpLink BandWidth Part (UL-BWP); and
monitoring a Random Access Response (RAR) in an initial DownLink BandWidth Part (DL-BWP).

17. The UE of claim 16, wherein Physical Random Access Channel (PRACH) resources are defined according to a legacy 3rd Generation Partnership Project (3GPP) standard.

18. The UE of claim 17, wherein the processor is further caused to execute an operation of receiving a definition of the PRACH resources in a System Information Block (SIB) message prior to sending the Random Access Preamble.

19. The UE of claim 16, wherein the processor is further caused to execute an operation of receiving higher layer information about the initial UL-BWP and the initial DL-BWP prior to sending the Random Access Preamble.

20. The UE of claim 16, wherein the processor is further caused to execute an operation of receiving a Random Access Response in reply to the Random Access Preamble on the initial DL-BWP.
